(19) United States
(12) Patent Application Publication
(10) Pub. No.: US 2020/0050194 A1
(43) Pub. Date: Feb. 13, 2020

(54) APPARATUS AND METHOD FOR SWITCHING CONTROL AUTHORITY OF AUTONOMOUS VEHICLE

(71) Applicant: Hyundai Mobis Co., Ltd., Seoul (KR)

(72) Inventor: A Ra CHOI, Yongin-si (KR)

(21) Appl. No.: 16/534,349

(22) Filed: Aug. 7, 2019

(30) Foreign Application Priority Data
Aug. 7, 2018 (KR) 10-2018-0091741

(51) Int. Cl. G05D 1/00; G06K 9/00; B60W 40/09; G06N 20/00

(52) U.S. Cl. CPC G05D 1/0061; G06K 9/00845; B60W 2040/0818; G06N 20/00; B60W 40/09

(57) ABSTRACT

An apparatus for switching a control authority of an autonomous vehicle may include: a capturing unit configured to capture an image of the inside of a vehicle and provide the captured image; a storage unit configured to store learning information and weights for inferring the presence and age of a passenger and whether a driver holds a steering wheel, based on deep learning; and a control unit configured to determine whether the passenger can drive the vehicle, by inferring the presence and age of the passenger through the learning information and weights stored in the storage unit from the image inputted from the capturing unit according to a manual mode switch request, infer whether the driver holds the steering wheel, and switch the control authority of the vehicle to a manual mode.

### CROSS-REFERENCES TO RELATED APPLICATION

The present application claims priority from and the benefit of Korean Patent Application No. 10-2018-0091741, filed on Aug. 7, 2018, which is hereby incorporated by reference for all purposes as if fully set forth herein.

### BACKGROUND

### Field

Exemplary embodiments relate to an apparatus and method for switching a control authority of an autonomous vehicle, and more particularly, to an apparatus and method for switching a control authority of an autonomous vehicle, which can determine whether a passenger can drive a vehicle, by inferring the presence and age of the passenger based on deep learning when a manual mode switch request is inputted during autonomous driving of an autonomous vehicle, and switch a control authority to a manual mode by inferring whether a driver holds a steering wheel.

### Discussion of the Background

Recently, a so-called autonomous vehicle has been suggested, which detects external environments (driving lane location, forward vehicle and the like), and performs driving control (steering control, accelerator control, brake control and the like) for the vehicle based on the detection result.

The autonomous vehicle does not always perform the driving control based on the detection result of the external environments (autonomous mode), but may be driven by a driver's operation (steering operation, brake pedal operation or accelerator pedal operation) based on the driver's intention (manual mode).

A switch-over from the autonomous mode to the manual mode is performed when a manual switch is manipulated, from the point of view that the driver's intention is confirmed.

The related art of the present invention is disclosed in Korean Patent Publication No. 10-2014-0043536 published on Apr. 10, 2014 and entitled “Method for Switching Control Authority of Autonomous Vehicle”.

When the control authority of the autonomous vehicle is switched only by the manual switch, the control authority may be easily switched between a driver and the vehicle. However, a child or a person who cannot drive the vehicle may take over the control authority.

The above information disclosed in this Background section is only for enhancement of understanding of the background of the invention and, therefore, it may contain information that does not constitute prior art.

### SUMMARY

Exemplary embodiments of the present invention are directed to an apparatus and method for switching a control authority of an autonomous vehicle, which can determine whether a passenger can drive a vehicle, by inferring the presence and age of the passenger based on deep learning when a manual mode switch request is inputted during autonomous driving of an autonomous vehicle, and switch a control authority to a manual mode by inferring whether a passenger holds a steering wheel.

In one embodiment, an apparatus for switching a control authority of an autonomous vehicle may include: a capturing unit configured to capture an image of the inside of a vehicle and provide the captured image; a storage unit configured to store learning information and weights for inferring the presence and age of a passenger and whether a passenger holds a steering wheel, based on deep learning; and a control unit configured to determine whether the passenger can drive the vehicle, by inferring the presence and age of the passenger through the learning information and weights stored in the storage unit from the image inputted from the capturing unit according to a manual mode switch request, infer whether the passenger holds the steering wheel, and switch a control authority of the vehicle to a manual mode.

The control unit may check the legal age of the passenger and whether the passenger has a license, when determining whether the passenger can drive the vehicle.

When the determination result indicates that the passenger cannot drive the vehicle, the control unit may stop the vehicle through an autonomous driving unit.

The apparatus may further include a seat moving unit configured to move the seat of the passenger in the vehicle. When the passenger who can drive the vehicle is not seated in a driver seat after the determining of whether the passenger can drive the vehicle, the control unit may operate the seat moving unit to move the seat of the passenger to the driver seat.

The apparatus may further include an output unit configured to inform a driver of the switch-over of the control authority by the control unit.

The apparatus of claim 1, wherein, when it is determined that the passenger can drive the vehicle, the control unit infers whether the passenger holds the steering wheel.

The apparatus of claim 6, wherein, when it is inferred that the passenger does not hold the steering wheel, the control unit stops the vehicle through an autonomous driving unit.

In another embodiment, a method for switching a control authority of an autonomous vehicle may include: receiving, by a control unit, an image from a capturing unit according to a manual mode switch request; inferring, by the control unit, the presence and age of a passenger from the input image through learning information and weights stored in a storage unit; determining, by the control unit, whether the passenger can drive the vehicle, after the inferring of the presence and age of the passenger; inferring, by the control unit, whether the passenger holds a steering wheel, according to the determination result of the determining of whether the passenger can drive the vehicle; and switching, by the control unit, a control authority of the vehicle to a manual mode according to the result of the inferring of whether the passenger holds the steering wheel.

The determining of whether the passenger can drive the vehicle may include checking the legal age of the passenger and whether the passenger has a license.

The method may further include: determining, by the control unit, whether the passenger who can drive the vehicle is seated in a driver seat, after the determining of whether the passenger can drive the vehicle; and operating, by the control unit, a seat moving unit to move the seat of the passenger to the driver seat, according to the result of the determining of whether the passenger is seated in the driver seat.

The method may further include stopping, by the control unit, the vehicle through an autonomous driving unit, when the result of the determining of whether the passenger can drive the vehicle indicates that the passenger cannot drive the vehicle.

The method may further include informing, by the control unit, a driver that the control authority was switched to the manual mode, through an output unit.

In the determining of whether the passenger can drive the vehicle, when it is determined that the passenger can drive the vehicle, the control unit may perform the step of the inferring whether the passenger holds the steering wheel.

In the inferring whether the passenger holds the steering wheel, when it is inferred that the passenger does not hold the steering wheel, the control unit may stop the vehicle through an autonomous driving unit.

In accordance with the embodiments of the present invention, the apparatus and method for switching a control authority of an autonomous driving may determine whether a passenger can drive the vehicle by inferring the presence or age of the passenger based on deep learning, when a switch-over to the manual mode is requested during the autonomous mode of the autonomous vehicle. Furthermore, the apparatus and method may infer whether the driver holds the steering wheel, and not only switch the control authority to the manual mode, but also stop the vehicle when the driver cannot drive the vehicle, thereby stably switching the control authority.

### BRIEF DESCRIPTION OF THE DRAWINGS

The accompanying drawings, which are included to provide a further understanding of the invention and are incorporated in and constitute a part of this specification, illustrate embodiments of the invention, and together with the description serve to explain the principles of the invention.

FIG. 1 is a block configuration diagram illustrating an apparatus for switching a control authority of an autonomous vehicle in accordance with an embodiment of the present invention.

FIG. 2 is a flowchart illustrating a method for switching a control authority of an autonomous vehicle in accordance with an embodiment of the present invention.

### DETAILED DESCRIPTION

The invention is described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure is thorough, and will fully convey the scope of the invention to those skilled in the art. Like reference numerals in the drawings denote like elements.

Various advantages and features of the present invention and methods accomplishing thereof will become apparent from the following description of embodiments with reference to the accompanying drawings. However, the present invention is not be limited to the embodiments set forth herein but may be implemented in many different forms. The present embodiments may be provided so that the disclosure of the present invention will be complete, and will fully convey the scope of the invention to those skilled in the art and therefore the present invention will be defined within the scope of claims. Like reference numerals throughout the description denote like elements.

Unless defined otherwise, it is to be understood that all the terms (including technical and scientific terms) used in the specification has the same meaning as those that are understood by those who skilled in the art. Further, the terms defined by the dictionary generally used should not be ideally or excessively formally defined unless clearly defined specifically. It will be understood that for purposes of this disclosure, “at least one of X, Y, and Z” can be construed as X only, Y only, Z only, or any combination of two or more items X, Y, and Z (e.g., XYZ, XYY, YZ, ZZ). Unless particularly described to the contrary, the term “comprise”, “configure”, “have”, or the like, which are described herein, will be understood to imply the inclusion of the stated components, and therefore should be construed as including other components, and not the exclusion of any other elements.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

As is traditional in the corresponding field, some exemplary embodiments may be illustrated in the drawings in terms of functional blocks, units, and/or modules. Those of ordinary skill in the art will appreciate that these block, units, and/or modules are physically implemented by electronic (or optical) circuits such as logic circuits, discrete components, processors, hard-wired circuits, memory elements, wiring connections, and the like. When the blocks, units, and/or modules are implemented by processors or similar hardware, they may be programmed and controlled using software (e.g., code) to perform various functions discussed herein. Alternatively, each block, unit, and/or module may be implemented by dedicated hardware or as a combination of dedicated hardware to perform some functions and a processor (e.g., one or more programmed processors and associated circuitry) to perform other functions. Each block, unit, and/or module of some exemplary embodiments may be physically separated into two or more interacting and discrete blocks, units, and/or modules without departing from the scope of the inventive concept. Further, blocks, units, and/or module of some exemplary embodiments may be physically combined into more complex blocks, units, and/or modules without departing from the scope of the inventive concept.

Hereafter, an apparatus and method for switching a control authority of an autonomous vehicle in accordance with an embodiment of the present invention will be described in detail with reference to the accompanying drawings. It should be noted that the drawings are not to precise scale and may be exaggerated in thickness of lines or sizes of components for descriptive convenience and clarity only. Furthermore, the terms as used herein are defined by taking functions of the invention into account and can be changed according to the custom or intention of users or operators. Therefore, definition of the terms should be made according to the overall disclosures set forth herein.

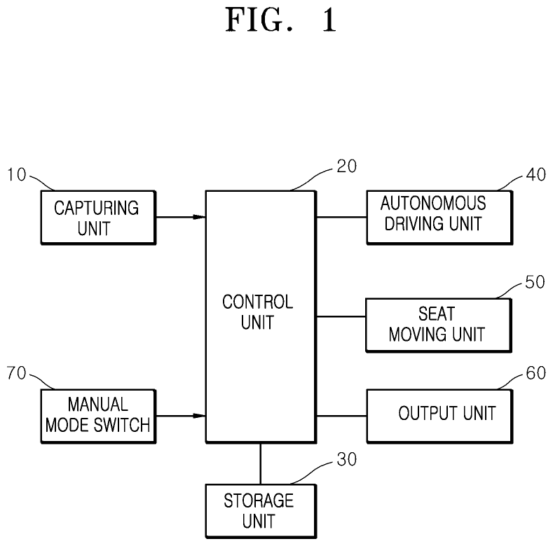

FIG. 1 is a block configuration diagram illustrating an apparatus for switching a control authority of an autonomous vehicle in accordance with an embodiment of the present invention.

As illustrated in FIG. 1, the apparatus for switching a control authority of an autonomous vehicle in accordance with the embodiment of the present invention may include a capturing unit 10, a storage unit 30, a control unit 20, a seat moving unit 50 and an output unit 60.

The capturing unit 10 may capture an image of the inside of a vehicle, and provide an image for each seat to the control unit to infer the presence or age of a passenger and whether a driver holds a steering wheel.

The capturing unit 10 may also provide the image for each seat, when learning is performed to infer the presence or age of the passenger and whether the driver holds the steering wheel, based on deep learning.

The storage unit 30 may store learning information and weights for inferring the presence or age of the passenger and whether the driver holds the steering wheel, based on deep learning.

The control unit 20 may determine whether the passenger can drive the vehicle, by inferring the presence or age of the passenger from the image inputted from the capturing unit 10 through the learning information and weights stored in the storage unit 30, according to a manual mode switch request. Then, the control unit 20 may infer whether the driver holds the steering wheel, and switch the control authority of the vehicle to the manual mode.

The manual mode switch request may be inputted through a manual mode switch 70, or inputted depending on a surrounding environment during autonomous driving.

The control unit 20 may infer the age of a passenger in each seat and check whether the inferred age of the passenger exceeds the legal age for driving, when determining whether the passenger can drive the vehicle. Alternatively, the control unit 20 may analyze a license submitted by a passenger through the capturing unit 10, and determine whether the passenger can drive the vehicle, depending on whether the passenger has a license.

When the determination result indicates that the passenger cannot drive the vehicle, the control unit 20 may stop the vehicle on the shoulder through the autonomous driving unit 40. That is, when the passenger cannot drive the vehicle even though the manual mode switch request was inputted, the control unit 20 may not switch the control authority of the vehicle to the manual mode, but stop the vehicle to secure the stability of the autonomous vehicle.

The seat moving unit 50 may move the seat of a passenger in the vehicle.

Therefore, when the passenger who can drive the vehicle is not seated in a driver seat after the determining of whether the passenger can drive the vehicle, the control unit 20 may operate the seat moving unit 50 to move the seat of the passenger whose age exceeds the legal age for driving, to the driver seat, thereby actively coping with the switch-over to the manual mode.

The output unit 60 may not only inform the driver of the switch-over of the control authority, such that the driver can recognize the switch-over of the control authority from the autonomous mode to the manual mode and manually drive the vehicle, but also inform the driver that the autonomous mode is maintained or a switch-over to the manual mode is impossible.

As described above, the apparatus for switching a control authority of an autonomous driving in accordance with the embodiment of the present invention may determine whether a passenger can drive the vehicle by inferring the presence or age of the passenger based on deep learning, when a switch-over to the manual mode is requested during the autonomous mode of the autonomous vehicle. Furthermore, the apparatus may infer whether the driver holds the steering wheel, and not only switch the control authority to the manual mode, but also stop the vehicle when the driver cannot drive the vehicle, thereby stably switching the control authority.

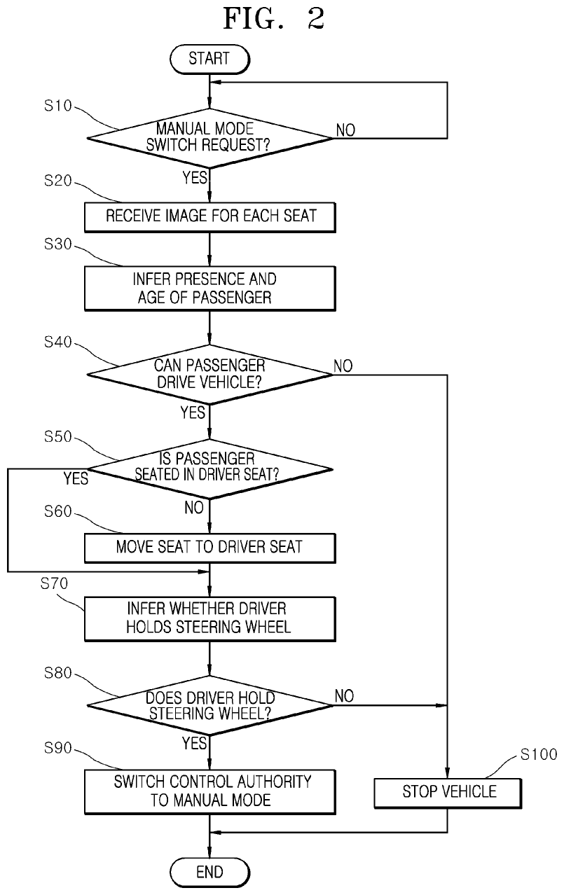

FIG. 2 is a flowchart illustrating a method for switching a control authority of an autonomous vehicle in accordance with an embodiment of the present invention.

As illustrated in FIG. 2, the method for switching a control authority of an autonomous vehicle in accordance with the embodiment of the present invention may begin with step S10 in which the control unit 20 determines whether a manual mode switch request was inputted.

The manual mode switch request may be inputted through the manual mode switch 70, or inputted depending on a surrounding environment during autonomous driving.

When the determination result of step S10 indicates that the manual mode switch request was inputted, the control unit 20 may receive an image for each seat, obtained by capturing the inside of the vehicle, from the capturing unit 10 in step S20.

After receiving the image for each seat in step S20, the control unit 20 may infer the presence and age of a passenger from the image for each seat by applying learning information and weights which are stored in the storage unit 30 based on deep learning, in step S30.

After inferring the presence and age of the passenger in step S30, the control unit 20 may determine whether the passenger can drive the vehicle, in step S40.

When the determination result of step S40 indicates that the passenger cannot drive the vehicle, the control unit 20 may stop the vehicle on the shoulder through the autonomous driving unit 40. Thus, when the passenger cannot drive the vehicle even though the manual mode switch request was made, the control unit 20 may not switch the control authority of the vehicle to the manual mode, but stop the vehicle to secure the stability of the autonomous driving, in step S100.

In step S40, the control unit 20 may infer the age of a passenger in each seat and check whether the inferred age of the passenger exceeds the legal age for driving, when determining whether the passenger can drive the vehicle. Alternatively, the control unit 20 may analyze a license submitted by a passenger through the capturing unit 10, and determine whether the passenger can drive the vehicle, depending on whether the passenger has a license.

On the other hand, when the determination result of step S40 indicates that the age of the passenger exceeds the legal age for driving or the passenger can drive the vehicle because the passenger has a license, the control unit 20 may determine whether the passenger is seated in the driver seat, in step S50.

When the determination result of step S50 indicates that the passenger is not seated in the driver seat, the control unit 20 may operate the seat moving unit 50 to move the seat of the passenger who can drive the vehicle, to the driver seat, in step S60.

On the other hand, when the determination result of step S50 indicates that the passenger is seated in the driver seat, the control unit 20 may infer from the image of the driver seat whether the driver holds the steering wheel, based on the learning information and weights which are obtained by deep learning and stored in the storage unit, in step S70.

After inferring that the driver holds the steering wheel in step S70, the control unit 20 may check whether the driver holds the steering wheel, in step S80.

When the check result of step S80 indicates that the driver does not hold the steering wheel, the control unit 20 may stop the vehicle on the shoulder through the autonomous driving unit 40 in step S100. That is, the control unit 20 may determine that the driver has no intention of switching the control authority to the manual mode, even though the manual mode switch request was inputted, and stop the vehicle.

When the check result of step S80 indicates that the driver holds the steering wheel, the control unit 20 may switch the control authority of the vehicle to the manual mode, such that the driver can manually drive the vehicle, in step S90.

After switching the control authority to the manual mode, the control unit 20 may inform the driver that the control authority of the vehicle was switched to the manual mode, through the output unit 60.

On the other hand, the control unit 20 may inform the driver that the autonomous mode is maintained or the switch-over to the manual mode is impossible, through the output unit 60.

As described above, the method for switching a control authority of an autonomous driving in accordance with the embodiment of the present invention may determine whether a passenger can drive the vehicle by inferring the presence or age of the passenger based on deep learning, when a switch-over to the manual mode is requested during the autonomous mode of the autonomous vehicle. Furthermore, the method may infer whether the driver holds the steering wheel, and not only switch the control authority to the manual mode, but also stop the vehicle when the driver cannot drive the vehicle, thereby stably switching the control authority.

Although preferred embodiments of the invention have been disclosed for illustrative purposes, those skilled in the art will appreciate that various modifications, additions and substitutions are possible, without departing from the scope and spirit of the invention as defined in the accompanying claims.

What is claimed is:

1. An apparatus for switching a control authority of an autonomous vehicle, comprising:
a capturing unit configured to capture an image of the inside of a vehicle and provide the captured image;
a storage unit configured to store learning information and weights for inferring the presence and age of a passenger and whether the passenger holds a steering wheel, based on deep learning; and
a control unit configured to determine whether the passenger can drive the vehicle, by inferring a presence and an age of the passenger through the learning information and weights stored in the storage unit from the image inputted from the capturing unit according to a manual ii mode switch request, infer whether the passenger holds the steering wheel, and switch the control authority of the vehicle to a manual mode.

2. The apparatus of claim 1, wherein the control unit checks a legal age of the passenger and whether the passenger has a license, when determining whether the passenger can drive the vehicle.

3. The apparatus of claim 1, wherein when the determination result indicates that the passenger cannot drive the vehicle, the control unit stops the vehicle through an autonomous driving unit.

4. The apparatus of claim 1, further comprising a seat moving unit configured to move a seat of the passenger in the vehicle,
wherein when the passenger who can drive the vehicle is not seated in a driver seat after the determining of whether the passenger can drive the vehicle, the control unit operates the seat moving unit to move the seat of the passenger to the driver seat.

5. The apparatus of claim 1, further comprising an output unit configured to inform a driver of the switch-over of the control authority by the control unit.

6. The apparatus of claim 1, wherein, when it is determined that the passenger can drive the vehicle, the control unit infers whether the passenger holds the steering wheel.

7. The apparatus of claim 6, wherein, when it is inferred that the passenger does not hold the steering wheel, the control unit stops the vehicle through an autonomous driving unit.

8. A method for switching a control authority of an autonomous vehicle, comprising:
receiving, by a control unit, an image from a capturing unit according to a manual mode switch request;
inferring, by the control unit, a presence and an age of a passenger from the image through learning information and weights stored in a storage unit;
determining, by the control unit, whether the passenger can drive the vehicle, after the inferring of the presence and age of the passenger;
inferring, by the control unit, whether a passenger holds a steering wheel, according to the determination result of the determining of whether the passenger can drive the vehicle; and
switching, by the control unit, a control authority of the vehicle to a manual mode according to the result of the inferring of whether the passenger holds the steering wheel.

9. The method of claim 8, wherein the determining of whether the passenger can drive the vehicle comprises checking a legal age of the passenger and whether the passenger has a license.

10. The method of claim 8, further comprising:
determining, by the control unit, whether the passenger who can drive the vehicle is seated in a driver seat, after the determining of whether the passenger can drive the vehicle; and
operating, by the control unit, a seat moving unit to move the seat of the passenger to the driver seat, according to a result of the determining of whether the passenger is seated in the driver seat.

11. The method of claim 8, further comprising stopping, by the control unit, the vehicle through an autonomous driving unit, when a result of the determining of whether the passenger can drive the vehicle indicates that the passenger cannot drive the vehicle.

12. The method of claim 8, further comprising informing, by the control unit, a driver that the control authority was switched to the manual mode, through an output unit.

13. The method of claim 8, wherein, in the determining of whether the passenger can drive the vehicle, when it is determined that the passenger can drive the vehicle, the control unit performs the step of the inferring whether the passenger holds the steering wheel.

14. The method of claim 13, wherein, in the inferring whether the passenger holds the steering wheel, when it is inferred that the passenger does not hold the steering wheel, the control unit stops the vehicle through an autonomous driving unit.
